(19) United States
(12) Patent Application Publication
(10) Pub. No.: US 2004/0124067 A1
(43) Pub. Date: Jul. 1, 2004

(54) Method for controlling press conveyors

(75) Inventor: Jose Fernandez Mostaza, Madrid (ES)

Correspondence Address: Ladas & Parry, 26 West 61 Street, New York, NY, 10023, US

(73) Assignee: CANTABRICO 95, S.L.

(21) Appl. No.: 10/630,226

(22) Filed: Jul. 30, 2003

(30) Foreign Application Priority Data
Aug. 2, 2002 (ES) 200201837

(51) Int. Cl. B65G 47/00

(52) U.S. Cl. 198/502.2

(57) ABSTRACT

A control method of the parts constituting the chain conveyors used in presses, which allows carrying out measurements on them while the conveyors are operating, with no physical contact with said parts, and whose accuracy is independent of the conveyor speed, which method consists of counting the pulses from a clock signal during the time the element to be measured is passing.

### FIELD OF THE ART

This application refers to a method for measuring and controlling objects in motion, whose accuracy is independent of speed and which particularly allows controlling, without physically contacting, the chain conveyors equipped with grippers, generally used in presses for conveying the printed copies from the printing machines to the subsequent processing room.

Since the technique herein disclosed makes it possible to measure or control any moving part or element, or any of its parts or components, repetitive or not, its application is considered for detecting status changes in any element of the conveyors controlled or of any components thereof, and particularly, the direct or indirect control of the grippers incorporated by the conveyors involved is considered, thereby making a complete control of the conveyor possible.

### BACKGROUND OF THE INVENTION

In presses, special chain conveyors are normally used to convey printed products from the printing machines to the subsequent processing rooms, in which chain conveyors each link incorporates a gripper device which allows catching, holding and conveying copies.

The conveyors are generally constituted of links swaged such that each one articulates with the one following it and the one preceding it to provide flexibility to the conveyor. As is evident, the greatest wear is concentrated in the hinge points as a result of the combined effect of the rotation on the joint and the stress to which the chain is subjected, said hinge points should therefore be controlled for ensuring their operation, as well as their resistance.

By virtue of the wear and tear accumulated with use, the chain normally stretches, which stretching must be compensated and, for this, normally different types of sensors are frequently used which, within certain limits, can absorb the stretching continuously, but which, once said limits are reached, require removing a chain link in order to have the setting margin of the tensioning device again.

This type of conveyors are normally provided with support and guide wheels, whose status must be controlled in order to replace them before their excessive wear affects the operation thereof.

The conveyors normally shift between rails, which rails have a shape and material depending on the manufacturers, and whose function is to guide them and support the weight of the conveyor as well as that of the load.

Each link of said chain conveyor is provided with a device, commonly called “gripper”, which allows catching, conveying and releasing the copies from one point to another, which is the purpose of this type of conveyors, therefore, for ensuring proper conveyor operation, their status must be monitored.

Until now, maintaining this type of conveyors has been very difficult to do because, in combination with the difficulty in detecting if there is any component of those disclosed which needs to be changed, for which there is no remedy other than in production observation (with all the drawbacks that this implies), it is difficult to recognize this fact subsequently in order to act once production has concluded, therefore they are normally marked while they are moving. The drawback is solved in this manner for some of the components, basically the grippers, but there is no solution for controlling the status of, for example, the links or the status of the wheels.

### SUMMARY OF THE INVENTION

The object of this invention is to provide a method for the measurement and control of the components of the chain conveyors used in presses during operation and, therefore, while moving. The method according to the invention does not require physical contact, and its accuracy is not affected by the conveyor speed.

The invention can be used for measuring certain magnitudes of the element or elements in motion which are of interest to know, or it can be used for controlling that said magnitudes are within preset tolerances, which ensure their correct operation, or, on the contrary, that they are outside of said tolerances, therefore making it necessary to replace the element or elements involved. It can also be used to detect changes in any magnitude or status changes in any component.

Thus, the measurement and control method of chain conveyors provided with grippers allows carrying out a thorough diagnosis of the conveyor, monitoring:

the status of the hinge joints between links,

the total stretching of the chain due to the accumulated wear,

the diameter of the support and/or guide wheels, and

the status of the grippers, and it can be put into practice in any type of conveyor, and at any speed.

The additional utility of the proposed invention is further based on the fact that by means of putting it into practice, not only is it possible to identify the elements not meeting predetermined requirements, but it is also possible to identify them such that they can be perfectly locatable for subsequent actions.

### DESCRIPTION OF THE PREFERRED EMBODIMENTS

The method according to the invention complies with three basic functions, namely: measurement, control and detection, and it uses two means to achieve it: direct measurement and comparison.

The measurement function allows measuring magnitudes of an element moving at any speed without physical contact with it, and, according to the specific application needs, two techniques are used:

1. When directly measuring a certain magnitude of an element in motion is needed, sensors will be incorporated which detect the passage time of said element at the measurement point, for example by means of counting the number of impulses generated by an pulse generator at a certain frequency according to the application for which it is intended, during the passage of said element between said detection sensors, whose signals are processed in the control system to calculate the measurement value in the desired units.

2. When what is needed is to control if a certain dimension is within certain margins or tolerances, a measurement by comparison technique is used, for example, a pass/no pass measurement technique using at least two precision sensors (laser photocell, inductive sensors or the like). For this, two sensors adjusted to the physical features existing in each case are provided which, with their spacing, copy the dimension to be checked, including the admissible tolerance, and they constitute the measurement gauge. The signals from these sensors are processed by the control system which will be responsible for detecting whether the measured element is within the range or tolerance.

The two measurement standard emitter sensors, for example two laser emitters, constituting the gauge should be oriented such that they perfectly “light up” the successive points of the system between which the measurement is to be taken, and they must be connected such that they add up, subtract or complement its effects according to the magnitude to be measured, to the technical features of the devices used, and to the processing the resulting signal is to be provided with.

For example, if said measurement standard emitters are arranged such that the spacing between them matches the length of a chain link plus the tolerance considered to be correct, and an initiator is provided such that the two emitters light up when a link starts to pass through the first sensor, if the set condition is that it is measured when the link reaches the first emitter and that the signal of the two emitters passes, as explained, if the considered link measurement is within the tolerance, the second emitter signal must also pass. However, in the same conditions, if the allowance is excessive and the link is subsequently outside of tolerances, the tail of the link will be delayed and this, when applying the standard, will make the first emitter signal to pass but not the second one.

In practice, the emitters are combined with a pulse generator to obtain measurement signals from the standard emitters synchronized to the moment in which they detect the passage of the element to be measured, and out of phase with each other such that one is positive when the other one is negative.

In these conditions, when the standard is applied to a link which is within tolerances, the two signals from the two emitters will add up and cancel out. However, in case there is excessive allowance, the signal from the second emitter will be delayed, therefore there will be an excessive allowance for a certain time when the two signals are added, which will create a peak that will be the signal used for reporting that that link is not within tolerances. Therefore, the behavior is that of a virtual pass/no pass gauge.

This process allows changing the tolerances to be admitted as compliant with the measurements to be checked, and it can be used to control any measurement with the sole condition of being able to assemble the corresponding sensors or any other equivalent device.

To control the total stretching caused in the chains due to accumulated wear of all the links, and the wear of the support and guide wheels, the first technique can be used and, if the data are stored and checked every so often, information about how said magnitudes evolve can be recovered.

In the case of stretching due to wear, once the total conveyor length is measured and the number of links is known, an average per-link measurement can be determined and, once known the margin of the tensioning device, if any, a warning can be automatically generated when it is appropriate to remove a link in order to recover the setting margin of the tensioning device.

To control the operation of the grippers used on press chain conveyors, the method is based on the detection of the changes of state occurring in said elements when they go from a standstill position to a working position, or, if this is not possible, in directly detecting the operation failures of the element involved. In both cases, this is done by means of specific sensors adapted to that function.

For the control method to be useful, each element to be controlled must be identified, and this is done by referencing them in relation to an origin, which functions as an initializer for all the controls.

The information collected for each element is stored in a data base where each one of them is perfectly identified, allowing subsequent processing by means of any statistical process to filter the data and reduce the noises always produced by this type of systems.

According to the invention, specific software is incorporated which allows elaborating the collected information and displaying the results in the established conditions, a display which can be local or remote, directly on the PLC display device of the system, on an auxiliary PC, through a corporate network, etc.

The final intended result is the identification of the conveyor elements with failures or which will have failures, so that their maintenance is quick and efficient.

Description of a Control Apparatus

An equipment to carry out the control method of the chain conveyors developed according to that being proposed, comprises, as an example, a measurement device and a control system, and can be incorporated in two ways:

Permanently: it permanently takes measurements and warns of the failures detected, thereby eliminating the need to carry out periodic revisions.

Periodically: it is assembled for a certain time and a data sample is taken, which allows detecting the status of the controlled element.

The measurement device is a mechanical element on which the measurement sensors (laser photocells or the like) are assembled, so that they should therefore be assembled such that their beam acts on the element to be measured.

The sensor signals are sent to the control system, which is connected to a display where information is exchanged between the operator and the system: worn parts, equipment failures, etc.

The control system is fundamentally constituted of a PLC equipped with the corresponding power source, memory cards, fast counting cards for high frequency signals, input and output cards, etc., in addition to an operation panel and failure display device. It is in this system where the information received from the measurement device will be processed and stored, which information can also be consulted or sent to other systems.

The measurement device will depend, where applicable, on the features of the conveyor to be measured or controlled and, for the purpose of disclosing in detail the different ways to use the disclosed techniques in practice, the application of the pass/no pass control method to the links, and the pulse counting method to the support and guide wheels, as well as to the stretching of the chain due to accumulated wear, will be considered. Furthermore, since the final objective of this type of controls is to ensure correct operation of the conveyors, a gripper operation control is added, which is the element performing the key function in the conveyor. For this, the attached drawings are referred to, wherein:

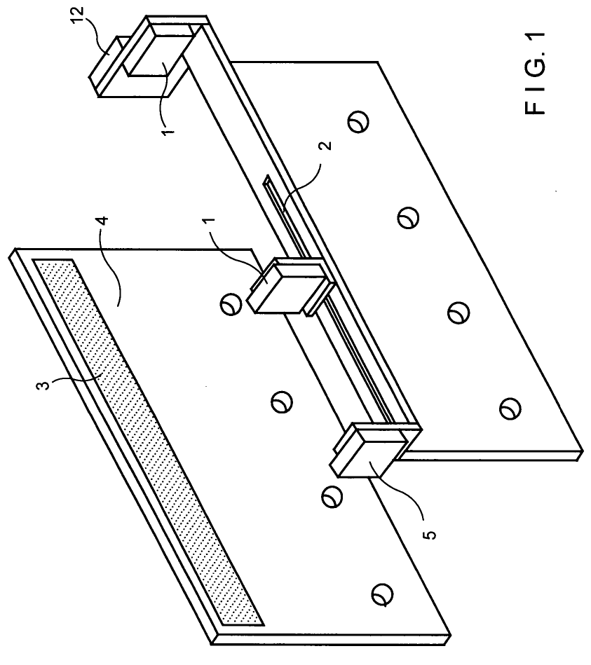

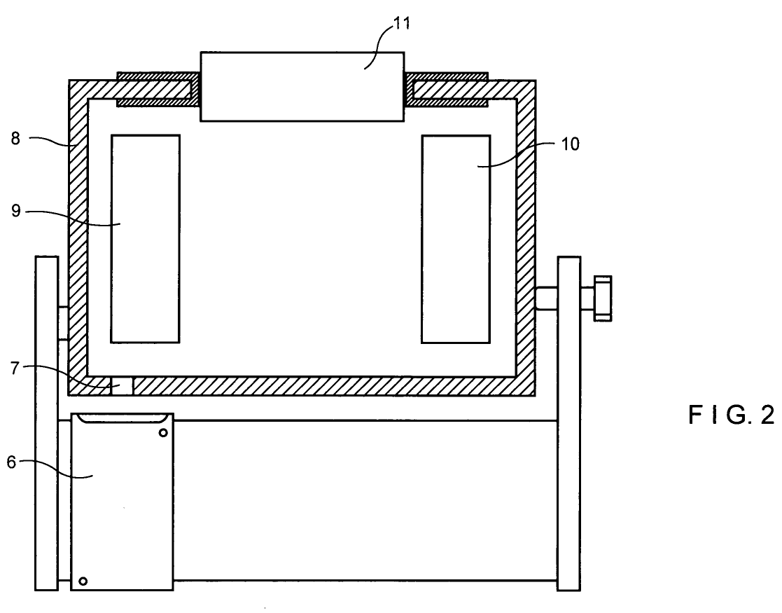

FIGS. 1 and 2 schematically show the elements incorporated on a conveyor of the type specified for carrying out the method of the invention.

In the drawings, the embodiment of the method of the invention is considered in commercially available conveyors of the Ferag Company, which have an area provided for inserting and removing links, which is in the delivery stations and which consist of detachable parts arranged on both sides of the conveyor, and which are fixed by means of four screws. The suitable area for other conveyors will have to be searched for and the necessary changes introduced.

To check the links, the comparison method is used, and to configure the pass/no pass gauge, two sensors (1) are arranged, which will be laser photocells or the like, physically spaced a distance equal to the one that will be used to check the links, including the tolerance. To facilitate adjusting the spacing, one of the sensors, or both, can be assembled on a dovetail-type slide or the like (2), facilitating its shifting.

The measurement adjustment to be arranged is facilitated if a graduated scale and a micrometric setting device, which also allows accurately knowing the measurement existing in each case, are assembled on it.

These pass/no pass gauges can be on one side only of the conveyor or on the two sides, depending on the physical features thereof, and it is sometimes necessary to assemble reflecting elements (3) to ensure correct operation of the emitters, which force considering both sides of the conveyor. In this case, the reflecting elements (3) must also be assembled such that their spacing can be regulated according to the spacing set for the emitters, or such that they cover the entire possible span of the latter. In the present case, it has been decided to show this second system, and the reflecting strip is assembled on a support (4), which is fixed on the opposite side of the photocells (1). Another more comfortable option could be to provide the reflecting elements with a magnetic base and to fix them directly in front of the emitters without assembling the support (4).

The moment to carry out the measurement for each link is determined by means of an initializer (not shown), which can be a laser, and which is the element providing the signal to apply the measurement standard to the corresponding link and to check if the measurement to be controlled is within the tolerances established in the standard.

This initializer can also be used for the measurements to be carried out by pulse counting, according to the already disclosed direct method.

To measure the diameter of the support wheels of one side, the photocell (5) from FIG. 1 is used. To measure the wheels of the other side which corresponds to the side where the grippers are assembled in conveyors of the type mentioned, the same process cannot be used, and the assembly shown in FIG. 2 must be used, in which the photocell (6) measures the support wheels (9) through the hole (7) made in the rail (8), the support wheels (10) being those wheels measured by the aforementioned photocell (5).

Finally, to measure the diameter of the guide wheels (11), a photocell (12) assembled at the suitable height will be used.

The total chain length will be known, by addition or by direct measurement, and, once the total number of links is known, the average measurement thereof is calculated, therefore, once the run of the tensioning device is known, the system can notify when it is necessary to remove a link in order to recover the setting margin of the latter.

The utility of the invention greatly depends on its capacity to identify faulty grippers in order to make it easier to repair or replace them due to the high number of grippers existing on this type of conveyors, and due to the repercussion that the failure of these elements has on the production process. This can be achieved in two ways, depending on the conveyor involved:

When there is a clear change of status in any of the components of said grippers between its standstill or working position, it will be enough to provide a suitable detector which detects said change and compares its status with the one said component should have in the phase of the process in which the gripper incorporating the element involved is in.

When it is not possible to use the preceding process, the detectors are arranged such that they detect if the grippers are carrying copies or not, and the results are compared, as in the preceding case, to what should happen in the case of correct operation according to the phase of the process in which the part involved is in.

The collected information is processed in the system control by means of a mathematic algorithm which filters the data and elaborates a failure report where the grippers which have failures are identified, and the number of failures each one of them has had is indicated.

Finally, for the system to be able to reference each controlled element, it is necessary to arrange an initializer on the conveyor which will serve to indicate to it to start another turn, and which serves as a reference to all the elements. A reference, such as a reflector, is normally fixed, for example, at a point of the conveyor which is lighted only by one laser photocell specifically used for this purpose. A metallic part and inductive detector, or any other equivalent process, can also be used. These elements have not been shown in the drawings.

1. A control method of the parts constituting chain conveyors used in presses, which allows carrying out measurements on them while the conveyors are operating, with no physical contact with said parts, and whose accuracy is independent of the conveyor speed, comprising:
counting the pulses from a clock signal during the time the element to be measured is passing.

2. A control method of the parts constituting chain conveyors used in presses, which allows carrying out measurements on them while the conveyors are operating, measurements with adjustable tolerance and which allow carrying out a pass/no pass type control on the elements in motion constituting the chain conveyors used in presses, with no physical contact with said parts, and whose accuracy is independent of the conveyor speed, comprising:
configuring a measurement standard with two emitters arranged so that the spacing between them is equal to the measurement to be checked, including the tolerance, which is adjustable, which standard will be applied to the element to be controlled by means of an initializer.

3. A method according to claim 2, characterized in that said emitters are synchronized laser beam emitters and which are applied by the action of an initializer.

4. A method according to claim 2, wherein the measurement standard is applied in synchronization with the system clock signal.

5. A method according to claim 4, wherein the signals from the measurement standard emitters are out of phase, such that one is positive when the other one is negative, and wherein the system adds up the two signals, therefore, when the standard is applied to a part that is within tolerances, the two signals will cancel each other out, but when the allowance is excessive, the signal from the second emitter will be delayed, and after adding the two signals, there will be a resulting signal which will be used by the system to detect the allowance.

6. A method according to any one of the preceding claims, characterized in that it detects a change of status occurred in any of the components of the grippers when going from a standstill position to a working position, and in that its status is compared to what said component should have in the phase of the process in which the gripper incorporating the element involved is in.

7. A method according to any one of claims 1 to 6, characterized in that it detects if each one of said grippers is carrying its corresponding load or not, and in that it compares the result of said detection to what said component should have in the phase of the process in which the gripper incorporating the element involved is in.

8. A method according to any one of claims 6 or 7, characterized in that the result of said comparison is processed in the system control by means of a mathematic algorithm which filters the data, and in that a failure report is elaborated which identifies the grippers which have had failures and indicates the number of failures each one of them has had.

9. A method for controlling the total stretching produced in the conveyor chain or chains due to the accumulated wear of all the links, consisting of measuring the total chain length every so often, using the already disclosed direct measurement method, storing the data, comparing it to the preceding data to see how said magnitude evolves and statistically defining a tendency curve.

10. A control method of the tensioning system of the conveyor according to claim 9, consisting in that once the total conveyor length is determined and the number of links forming it is known, an average per-link measurement is determined and, once the setting margin of the tensioning device is known, a warning is automatically generated when it is convenient to remove a link in order to recover the setting margin of the tensioning device.

11. A method for controlling the wear of the support and guide wheels of press conveyors, consisting of measuring the diameters of each one every so often, using the already disclosed direct measurement method, storing the data, comparing it to the preceding data to see how said magnitude evolves and statistically defining a tendency curve.

12. A preventive maintenance method for the links and support and guide wheels of press conveyors, consisting in that once the evolution of the wear that each one follows is known according to the method of claims 9 and 11, and once the value at which the element should be changed is set, the system will notify with the prior notice established when the element involved should be changed, based on the tendency curve data and on the estimated operation hours.
